(19) United States
(12) Patent Application Publication
(10) Pub. No.: US 2024/0209171 A1
(43) Pub. Date: Jun. 27, 2024

(54) METHOD FOR PRODUCING CELLULAR POLYOLEFIN-BASED PLASTIC PARTICLES

(71) Applicant: JSP Corporation, Tokyo (JP)

(72) Inventors: Pascal DZIKOWSKI, Estrées-Saint-Denis (FR); Jan JANOUŠEK, Estrées-Saint-Denis (FR)

(73) Assignee: JSP Corporation, Tokyo (JP)

(21) Appl. No.: 18/558,025

(22) PCT Filed: Apr. 27, 2022
(86) PCT No.: PCT/EP2022/061256

§ 371 Date: Oct. 30, 2023

(30) Foreign Application Priority Data
Apr. 30, 2021 (EP) 21171657.6

(51) Int. Cl. C08J 9/18; C08J 9/228

(52) U.S. Cl. CPC C08J 9/18; C08J 9/228; C08J 2201/032; C08J 2201/034; C08J 2323/06; C08J 2323/12; C08J 2323/16

(57) ABSTRACT

The invention relates to a method for producing cellular plastic particles, including the steps of: —providing a plastic material in the form of pre-expanded plastic material particles, —loading the pre-expanded plastic material particles with a blowing agent under the influence of pressure, —expanding the pre-expanded plastic material particles loaded with blowing agent in order to produce cellular plastic particles, more particularly, cellular plastic particles having lower density, under the influence of temperature, in which the expanding of the plastic material particles loaded with blowing agent is carried out under the influence of temperature by irradiation of the plastic material particles loaded with blowing agent with high-energy thermal radiation, more particularly, infrared radiation.

The invention relates to a method for producing cellular polyolefin-based plastic particles.

Methods for producing cellular polyolefin-based plastic particles, which are further processed, more particularly, to produce particle foam moldings, are known per se from the related art.

Known methods for producing cellular polyolefin-based plastic particles are based on a two-step process, which provides for, in a first step, melting a thermoplastic polyolefin-based plastic material in an extruder, and loading the thermoplastic polyolefin-based plastic material melt, thus produced within the extruder, with a blowing agent, and, in a second step, granulating or comminuting the thermoplastic polyolefin-based plastic material emerging from the extruder in strand form and expanding or being expanded due to the blowing agent.

In the first step of a corresponding method, the blowing agent is dissolved in the thermoplastic plastic material melt due to the pressure and temperature conditions prevailing in the extruder. After the thermoplastic polyolefin-based plastic material loaded with blowing agent exits the extruder, due to the pressure drop, the polyolefin-based plastic material expands as a result of the blowing agent transitioning into the gas phase.

Through the granulation or comminution, for example, by means of a cutting device, of the polyolefin-based plastic material which exits the extruder in strand form, and, as described, immediately expands due to the blowing agent after exiting the extruder, taking place in the second step of a corresponding method, cellular polyolefin-based plastic particles form, which can be processed further into a particle foam molding in a separate processing process.

First of all, known methods are comparatively complex in terms of both system and process technology. In addition, the cellular polyolefin-based plastic particles that can be produced using known methods have room for improvement in terms of properties such as, for example, size, morphology and distribution of cells; the possibilities of influencing the corresponding properties of the cellular polyolefin-based plastic particles in terms of system or process technology are markedly limited with known methods.

Furthermore, it is not possible with known methods to produce cellular polyolefin-based plastic particles starting from a pre-expanded polyolefin-based plastic material. This is particularly true because the extrusion-based process described damages or destroys the structure of the pre-expanded polyolefin-based plastic material particles, more particularly, due to the mechanical and thermal energy input.

This applies, more particularly, to autoclave processes that are known per se, in which pre-expanded polyolefin-based plastic material particles are expanded batchwise and thus discontinuously to form foam beads using superheated steam in an autoclave device (so-called post-expander/continuous expander). Things that need to be improved here include energy inefficiency, the infrastructural requirements for steam generation and supply, the risk of a deterioration in the morphology of the foam beads produced over their entire volume, a high degree of scatter due to different thermal conditions in the different areas of the autoclave device) and the necessary subsequent drying processes to remove the moisture due to the superheated steam, among others.

Based on this, the present invention is based on the object of providing an improved method for producing cellular polyolefin-based plastic particles, which also makes it possible to produce cellular polyolefin-based plastic particles starting from pre-expanded polyolefin-based plastic material particles, more particularly, with properties that can be set in a targeted manner for subsequent processing into particle foam moldings and their application or usage properties.

The object is achieved by a method according to claim 1. The dependent claims relate to possible embodiments of the method.

A first aspect of the invention relates to a method for producing cellular polyolefin-based plastic particles; the method described herein is therefore generally used to produce cellular polyolefin-based plastic particles. The polyolefin-based plastic particles that are producible or produced according to the method are, consequently, polyolefin-based plastic particles which have a cellular structure at least in sections, typically wholly. The cellular polyolefin-based plastic particles can also have a certain (further) expansion capacity, more particularly, due to a certain blowing agent content—be it a residue from the method described, or subsequently introduced in a separate process step. The cellular polyolefin-based plastic particles that are producible or produced according to the method can, consequently, be expandable and/or (mechanically) compressible due to their cellular structure. In any event, the cellular polyolefin-based plastic particles that are producible or produced according to the method can be referred to or considered as “foam particle” or “foamed beads”. As will be seen below, the method can also be referred to or considered as a method for radiation-based modification, i.e., more particularly, for the post- or further expansion of pre-expanded polyolefin-based plastic particles. The radiation-based modification serves, more particularly, for targeted radiation-based influencing the cellular properties and thus the cellular structure of corresponding pre-expanded polyolefin-based plastic particles, which is understood to mean, as mentioned, more particularly, post- or further expansion.

The cellular polyolefin-based plastic particles which are producible or produced according to the method and which are referable or also referred to below, in short, as “plastic particles” or “cellular plastic particles”, can be further processed into a particle foam molding in one or more independent subsequent processes. The further processing of the cellular plastic particles into a particle foam molding can be carried out using steam or superheated steam (steam-based) or without the use of steam or superheated steam (non-steam based or dry).

The steps of the method for producing cellular plastic particles are explained in more detail below.

In a first step of the method, a plastic material is provided in the form of pre-expanded polyolefin-based plastic material particles. The pre-expanded polyolefin-based plastic material particles provided according to the method, also referred to below, in short, as “pre-expanded plastic material particles”, can also, optionally, be referred to as “pre-expanded plastic particles”. The plastic material to be considered as the starting material, which is, consequently, a polyolefin-based particle foam material, and therefore already a cellular polyolefin-based plastic material, is provided in the first step of the method in the form of pre-expanded plastic material particles. Thus, the pre-expanded plastic material provided is particulate, i.e., more particularly, bulk-like or bulk-shaped. Consequently, in the first step, at least one measure is generally carried out for providing a particulate, i.e., more particularly, bulk-like or bulk-shaped, pre-expanded plastic material in the form of corresponding pre-expanded plastic material particles. Depending on the material composition or modification, the density of the pre-expanded plastic material particles provided in the first step of the method is typically below 1 g/cm³, more particularly, in a range between 0.05 and 1.5 g/cm³, due to the cellular structure, which results in the pre-expansion properties of the pre-expanded plastic material particles provided; consequently, the matrix of the pre-expanded plastic material particles provided has a porous or cellular structure.

Despite its cellular structure, the matrix of the pre-expanded plastic material particles can optionally contain at least one additive or auxiliary material, such as, for example, elongated, spherical or platelet-shaped fillers. More particularly, for pre-expanded plastic material particles with additives or auxiliary materials, the density can optionally be also above 1 g/cm³, depending on the concentration. Corresponding additives or auxiliary materials can optionally be present in cellular form itself or can have a cellular effect.

The first step of the method can be carried out, optionally at least partially automatable or partially automated, by means of a provision device, which is set up for the continuous or discontinuous provision of a corresponding plastic material in the form of pre-expanded plastic material particles. A corresponding provision device can be, for example, a conveyor device, by means of which the pre-expanded plastic material particles, which are to be processed into corresponding cellular plastic particles, can be conveyed to or into a loading device carrying out the second step of the method. A corresponding conveyor device can be designed as, for example, a belt conveyor device or flow conveyor device, or can include such device. Consequently, conveying the pre-expanded plastic material particles to or into a loading device which carries out the second step of the method, can include receiving the pre-expanded plastic material particles into a conveying flow; consequently, the pre-expanded plastic material particles can be conveyed by means of a conveying flow to or into a loading device which carries out the second step of the method.

In a second step of the method, the pre-expanded plastic material particles are loaded with a blowing agent, at least under the influence of pressure. In the second step, accordingly, the pre-expanded plastic material particles are loaded with a blowing agent at least under the influence of pressure—optionally, depending on the material, a certain (elevated) temperature can also be applied in addition to a certain pressure. In the second step, accordingly, at least one measure for loading the pre-expanded plastic material particles with a blowing agent is generally carried out at least under the influence of pressure, i.e., at least pressurized. Phenomenologically, in the second step of the method, the blowing agent is typically enriched in the respective pre-expanded plastic material particles. The enrichment of the blowing agent in the respective pre-expanded plastic material particles can result, for example, from or through absorption and/or dissolution processes of the blowing agent in the respective pre-expanded plastic material particles, more particularly, depending on the chemical configuration of the pre-expanded plastic material particles, the blowing agent and the additives or auxiliary materials it optionally may contain, and, as previously mentioned, depending on the pressure or temperature conditions, which are typically also chosen depending on the materials. Because of the cellular structure of the pre-expanded plastic material particles an enrichment or accumulation of the blowing agent can also occur within the cell spaces provided by the cellular structure; i.e., the inner volume of a respective pre-expanded plastic material defined by the cell spaces can be utilized as a receiving space for the reception of blowing agent taking place in the second step of the method.

The pressure level in the second step of the method is typically chosen, particularly depending on the material, so that the cellular structure of the pre-expanded plastic material particles is not damaged; more particularly, the pressure level in the second step of the method is chosen so that the cellular structure of the pre-expanded plastic material particles is not damaged in an undesirable manner due to pressure. i.e., it does not deform plastically and even collapse completely, for example. In this context, the effective difference between external loading pressure and internal cellular pressure is particularly important.

The same applies, more particularly, to the rate of pressure rise, i.e., the rate at which the external pressure is increased from an initial level to a target level in the second step. Typically, the rate of pressure rise is in a range between 0.001 bar per minute and 1000 bar per minute. More particularly, between 0.01 bar per minute and 1000 bar per minute, further, more particularly, between 0.1 bar and 1000 bar per minute, further, more particularly, between 1 bar and 1000 bar per minute, further, more particularly, between 2, 3, 4, 5, 6, 7, 8, 9 or 10 bar and 1000 bar per minute, further, more particularly, between 15, 20, 25, 30, 35, 40, 45, 50, 55, 60, 65, 70, 75, 89, 85, 90, 95 or 100 bar per minute and 1000 bar per minute, further, more particularly, between 125, 150, 175, 200, 225, 250, 275, 300, 325, 350, 375, 400, 425, 450, 475, 500, 525, 550, 575, 600, 625, 650, 675, 700, 735, 750, 775, 800, 825, 850, 875, 900, 925, 950 or 975 bar per minute and 1000 bar per minute. Any and all intermediate values not explicitly listed here are also conceivable.

Gases such as, for example, carbon dioxide or a mixture containing carbon dioxide and/or nitrogen, such as, for example, air can be used as a blowing agent. Generally, any combustible or non-combustible organic gases, i.e., more particularly, butane or pentane, or inert gases, such as, for example, noble gases, i.e., more particularly, helium, neon, argon; or nitrogen, or mixtures thereof can be used. Consequently, the term “blowing agent” can also include a mixture of chemically and/or physically different blowing agents. The selection of the blowing agent typically takes into account its absorption capacity in the pre-expanded plastic material particles, i.e., taking into account the chemical and/or physical configuration or composition of the pre-expanded plastic material particles. If the pre-expanded plastic material particles contain additives or auxiliary materials, the properties such as, for example, the chemical and/or physical configuration of the additives or auxiliary materials can also be taken into account when selecting the blowing agent.

The second step of the method can, optionally at least partially automatable or partially automated, be carried out by means of a loading device which is set up to load the pre-expanded plastic material particles with a blowing agent at least under the influence of pressure, or to carry out a corresponding loading process. A corresponding loading device can, for example, be designed as, or include, an autoclave device, i.e., generally, as a pressure container device including an optionally temperature controllable pressure or process space. A corresponding loading device can also have a temperature control device, which is set up to control the temperature of a corresponding pressure or process space. A corresponding loading device can, in any case, have a control and/or regulation unit which is implemented in hardware and/or software, which is set up for control and/or regulation, i.e., generally, for setting certain dynamic and/or static pressure and/or temperature parameters within a corresponding pressure or process space.

In a third step of the method, the pre-expanded plastic material particles loaded with blowing agent are expanded to produce cellular plastic particles under the influence of temperature, i.e., more particularly, elevated temperature. Consequently, the pre-expanded plastic material particles loaded with blowing agent are typically exposed to elevated temperature in the third step of the method, i.e., generally, to thermal energy, which leads to outgassing and/or expansion of the blowing agent contained in the pre-expanded plastic material particles. This is typically done dry, i.e., without external influence of fluids, such as, for example, steam or water. More particularly, the outgassing of the blowing agent in the cells and the matrix areas of the thermally softening or softened pre-expanded plastic material particles causes the plastic material particles to expand again or further, which, after cooling or “freezing”, results in the formation of plastic particles having a permanent cellular structure that may have changed compared to the starting material, for example, in terms of cell number and/or shape and/or size, and thus in the formation of the cellular plastic particles to be produced. In the third step of the method, consequently, at least one measure for outgassing or expanding the blowing agent contained in the cells and the matrix areas of the pre-expanded plastic material particles, which are, at least by the influence of temperature and thus at least thermally, softening or softened, is carried out to produce cellular plastic particles. Phenomenologically, in the third step of the method, more particularly, due to the outgassing or desorption of the blowing agent from the cells and the matrix areas of the softening or softened pre-expanded plastic material particles, a further cell growth and, optionally, a renewed cell formation with subsequent cell growth within the pre-expanded plastic material particles occur, which results in the cellular plastic particles to be produced, which have a, optionally significantly, lower density compared to the pre-expanded plastic particles. The cell formation, if such occurring, is typically based on the aforementioned desorption of the blowing agent at nucleation points in the plastic material particles that are softening or softened by the influence of temperature, while the cell growth is typically based on a positive pressure-related expansion of the blowing agent in already formed or existing cells. As also mentioned, the cellular structure formed in this way or the further expansion state realized in this way is permanently “frozen” or fixed by the, or a, temperature reduction of the cellular plastic particles produced in this way, that is to say by cooling them, for example, by the environment.

Consequently, principally, it is true that after completion of the pressurization, which occurs in the second step of the method, i.e., in the event of a pressure drop, more particularly, to normal or standard conditions, outgassing or desorption processes occur within respective pre-expanded plastic material particles loaded with blowing agent and typically thermally softened. The outgassing or desorption processes of the blowing agent represent an essential prerequisite for the cell growth processes required for the production of cellular plastic particles and, optionally, cell formation processes within respective plastic material particles. In the third step of the method, more particularly, due to corresponding outgassing or desorption processes, the cellular plastic particles to be produced according to the method are formed from the typically thermally softened, pre-expanded plastic material particles present after the second step of the method which are loaded with blowing agent.

As mentioned, the cellular plastic particles to be produced or produced according to the method have a lower density than the pre-expanded plastic particles, so that the method, as has been mentioned also, serves to produce cellular plastic particles of lower density and thus can be referred to or considered also as a method for radiation-based modification, i.e., more particularly, for radiation-based post- or further expansion, of pre-expanded plastic particles.

As will be explained below, by controlling corresponding outgassing or desorption-related cell formation and cell growth processes, optionally, cellular structures with locally different cell properties and thus graded cellular plastic particles can be realized.

Generally, it is true that, according to the method, more particularly, cellular plastic particles with a cell size in a range between 0.5 and 250 μm can be produced. Consequently, the actual cell size—of course, typically reference is made to an average—can be set over a very wide range and thus tailored according to the process depending on the selected process conditions. The same applies to any distribution of cell sizes within respective cellular plastic particles.

More particularly, it is true that, with the method described herein, cellular plastic particles with a (mean) cell size below 250 μm, more particularly below 240 μm, further, more particularly below 230 μm, further, more particularly below 220 μm, further, more particularly below 210 μm, further, more particularly below 200 μm, further, more particularly below 190 μm, further, more particularly below 180 μm, further, more particularly below 170 μm, further, more particularly below 160 μm, further, more particularly below 150 μm, further, more particularly below 140 μm, further, more particularly below 130 μm, further, more particularly below 120 μm, further, more particularly below 110 μm, further, more particularly below 100 μm, further, more particularly below 90 μm, further, more particularly below 80 μm, further, more particularly below 70 μm, further, more particularly below 60 μm, further, more particularly below 50 μm, further, more particularly below 45 μm, further, more particularly below 40 μm, further, more particularly below 35 μm, further, more particularly below 30 μm, further, more particularly below 25 μm, further, more particularly below 24 μm, further, more particularly below 23 μm, further, more particularly below 22 μm, further, more particularly below 21 μm, further, more particularly below 20 μm, further, more particularly below 19 μm, further, more particularly below 18 μm, further, more particularly below 17 μm, further, more particularly below 16 μm, further, more particularly below 15 μm, further, more particularly below 14 μm, further, more particularly below 13 μm, further, more particularly below 12 μm, further, more particularly below 11 μm, further, more particularly below 10 μm, or even lower, can be formed. Any and all intermediate values not explicitly listed here are also conceivable.

The third step of the method can be carried out, optionally at least partially automatable or partially automated, by means of an expansion device which is set up for the radiation-based expanding of the blowing agent for producing cellular plastic particles at least under the influence of temperature to carry out a corresponding radiation-based expansion process. A corresponding expansion device is typically designed as, or includes, a radiation-based heating device, i.e., generally, as a temperature control device including a temperature control or process space, the temperature of which is controllable or controlled at least based on radiation. A corresponding temperature control device can also have a conveyor device, which is set up to convey the plastic material particles to be expanded along a conveyor line through a corresponding temperature control or process space. In any event, a corresponding expansion device can have a control and/or regulation unit implemented in hardware and/or software, which is set up for control and/or regulation, i.e., generally, for setting certain dynamic and/or static conveying and/or temperature and/or radiation parameters within a corresponding temperature control or process space.

More particularly, the third step of the method can optionally be carried out continuously, which is advantageous compared to the batchwise, autoclave-based processes mentioned at the beginning.

The density of the cellular plastic particles produced in the third step of the method is typically well below the initial density of the pre-expanded plastic material particles provided in the first step, which results in the cellular properties of the plastic particles that are producible or produced according to the method. Accordingly, the bulk density of the cellular plastic particles produced in the third step of the method is well below the bulk density of the pre-expanded plastic material particles provided in the first step of the method.

The cellular plastic particles produced in the third step of the method are, as mentioned above, typically further or post-expandable; this can represent an essential property for the described, more particularly, steam-based or non-steam-based, further processing of the cellular plastic particles for the production of particle foam moldings.

Consequently, the method is distinguished from known methods by a special dynamic process control, which requires softening which is required for expansion, but in contrast to an extrusion process, no complete melting of a pre-expanded plastic material loaded with blowing agent and thus no pressure- and temperature-intensive loading of a plastic material melt with blowing agent. The dynamic process control. i.e., more particularly, the rapid (volume) heating that is possible—in contrast to convective and conductive energy transport in steam-based post-foaming—is also important for high energy efficiency and the significantly finer cell morphology mentioned below (due to the lack of time for cell fusions). The method is therefore associated with a (significantly) simplified system and process technological effort for its implementation, as pre-expanded plastic material particles loaded with a blowing agent, and corresponding plastic material particles loaded with blowing agent can be converted into cellular plastic particles at least under the influence of temperature, more particularly, under the influence of temperature and pressure.

In addition, the properties of the cellular plastic particles that are producible or produced according to the method, more particularly, with regard to the number, size, shape and distribution of the cells, are improved, which results from the easily settable and very well controllable process conditions as part of the loading which occurs in the second step of the method and as part of the expanding which occurs in the third step of the method.

In contrast to the autoclave-based expansion processes described at the beginning, the method enables a continuous expansion process of corresponding pre-expanded plastic particles loaded with blowing agent, which does not require subsequent drying due to the lack of use of superheated steam.

The method thus enables a significantly expanded process window that can be precisely set or regulated for each plastic material, which in principle makes it possible to produce cellular plastic particles with desired properties from any (thermoplastic) pre-expanded plastic material particles.

As indicated, the loading of the pre-expanded plastic material particles with a blowing agent can be carried out under the influence of pressure and temperature. Consequently, the parameters that can be varied, more particularly, depending on the material, for loading the pre-expanded plastic material particles with blowing agent and subsequently for the targeted setting of certain properties of the cellular plastic particles to be produced or produced, are, consequently, initially the pressure and temperature conditions prevailing in the second step of the method. Of course, time is also important, i.e., more particularly, the course and duration of the pressure and temperature conditions, in the second step of the method, a parameter which has influence on the loading of the pre-expanded plastic material particles with blowing agent, i.e., more particularly, the absorption of the blowing agent in the pre-expanded plastic material particles.

Specific parameters for carrying out the second step of the method are given below by way of example.

Loading the pre-expanded plastic material particles with the, or a, blowing agent can, for example, more particularly, depending on the chemical composition of the pre-expanded plastic material particles and/or the blowing agent, be carried out at a pressure in a range between 1 and 200 bar, more particularly, in a range between 1 and 190 bar, further, more particularly, in a range between 1 and 180 bar, further, more particularly, in a range between 1 and 170 bar, further, more particularly, in a range between 1 and 160 bar, further, more particularly, in a range between 1 and 150 bar, further, more particularly, in a range between 1 and 140 bar, further, more particularly, in a range between 1 and 130 bar, further, more particularly, in a range between 1 and 120 bar, further, more particularly, in a range between 1 and 110 bar, further, more particularly, in a range between 1 and 100 bar, further, more particularly, in a range between 1 and 90 bar, further, more particularly, in a range between 1 and 80 bar, further, more particularly, in a range between 1 and 70 bar, further, more particularly, in a range between 1 and 60 bar, further, more particularly, in a range between 1 and 50 bar, further, more particularly, in a range between 1 and 40 bar, further, more particularly, in a range between 1 and 30 bar, further, more particularly, in a range between 1 and 20 bar, further, more particularly, in a range between 1 and 10 bar. Instead of 1 bar, 2, 3, 4, 5, 6, 7, 8, 9 or 10 bar can also be used as the lower limit. The aforementioned pressures, as mentioned by way of example, refer, more particularly, to pressures within a pressure or process space of a corresponding loading device when the second step of the method is carried out. Any and all intermediate values not explicitly listed here are also conceivable.

As mentioned, the pressure level and, more particularly, the pressure rise rate in the second step of the method are, more particularly, depending on the material, typically chosen so that the cellular structure of the pre-expanded plastic material particles is not damaged, more particularly, the pressure level and, more particularly, the pressure rise rate in the second step of the method are chosen so that the cellular structure of the pre-expanded plastic material particles does not deform plastically due to pressure (effective difference between external loading pressure and internal cellular pressure) and possibly even collapse.

Loading the pre-expanded plastic material particles with the, or a, blowing agent can, for example, more particularly, depending on the chemical composition of the pre-expanded plastic material particles and/or the blowing agent, be carried out at a temperature in a range between 0 and 250° C., further, more particularly, in a range between 0 and 240° C., further, more particularly, in a range between 0 and 230° C., further, more particularly, in a range between 0 and 220° C., further, more particularly, in a range between 0 and 210° C., further, more particularly, in a range between 0 and 200° C. further, more particularly, in a range between 0 and 190° C., further, more particularly, in a range between 0 and 180° C., further, more particularly, in a range between 0 and 170° C., further, more particularly, in a range between 0 and 160° C., further, more particularly, in a range between 0 and 150° C., further, more particularly, in a range between 0 and 140° C., further, more particularly, in a range between 0 and 130° C., further, more particularly, in a range between 0 and 120° C., further, more particularly, in a range between 0 and 110° C., further, more particularly, in a range between 0 and 100° C., further, more particularly, in a range between 0 and 90° C., further, more particularly, in a range between 0 and 80° C., further, more particularly, in a range between 0 and 70° C., further, more particularly, in a range between 0 and 60° C., further, more particularly, in a range between 0 and 50° C., further, more particularly, in a range between 0 and 40° C., further, more particularly, in a range between 0 and 30° C., further, more particularly, in a range between 0 and 20° C. The aforementioned temperatures, as mentioned by way of example, refer, more particularly, to temperatures within a pressure or process space of a corresponding loading device when the second step of the method is carried out. Any and all intermediate values not explicitly listed here are also conceivable.

Loading the pre-expanded plastic material particles with the, or a, blowing agent can, for example, more particularly, depending on the chemical composition of the pre-expanded plastic material particles and/or the blowing agent, be carried out for a period of time in a range between 0.1 and 1000 h, more particularly, in a range between 0.1 and 950 h, further, more particularly, in a range between 0.1 and 900 h. further, more particularly, in a range between 0.1 and 850 h, further, more particularly, in a range between 0.1 and 800 h, further, more particularly, in a range between 0.1 and 750 h, further, more particularly, in a range between 0.1 and 700 h, further, more particularly, in a range between 0.1 and 650 h, further, more particularly, in a range between 0.1 and 600 h, further, more particularly, in a range between 0.1 and 550 h, further, more particularly, in a range between 0.1 and 500 h, further, more particularly, in a range between 0.1 and 450 h, further, more particularly, in a range between 0.1 and 400 h, further, more particularly, in a range between 0.1 and 350 h, further, more particularly, in a range between 0.1 and 300 h, further, more particularly, in a range between 0.1 and 250 h, further, more particularly, in a range between 0.1 and 200 h, further, more particularly, in a range between 0.1 and 150 h, further, more particularly, in a range between 0.1 and 100 h, more particularly, in a range between 0.1 and 90 h, more particularly, in a range between 0.1 and 80 h, more particularly, in a range between 0.1 and 70 h, more particularly, in a range between 0.1 and 60 h, more particularly, in a range between 0.1 and 50 h, more particularly, in a range between 0.1 and 40 h, more particularly, in a range between 0.1 and 30 h, more particularly, in a range between 0.1 and 20 h, more particularly, in a range between 0.1 and 10 h. The aforementioned durations, as mentioned by way of example, refer, more particularly, to the pressurization or temperature exposure of the plastic material particles within a pressure or process space of a corresponding loading device when the second step of the method is carried out. Any and all intermediate values not explicitly listed here are also conceivable.

Specific parameters for carrying out the third step of the method are given below by way of example:

Expanding the plastic material particles loaded with blowing agent to produce the cellular plastic particles under the influence of temperature, more particularly, depending on the chemical composition of the plastic particle material loaded with blowing agent and/or the blowing agent, can, for example, be carried out at normal pressure, i.e., an ambient pressure of approx. 1 bar. A particular pressure level, such as, for example, a positive or a negative pressure level is therefore possible for expanding the pre-expanded plastic material particles loaded with blowing agent to produce the cellular plastic particles, but is not absolutely necessary, which fundamentally simplifies the expansion process.

Expanding the plastic material particles loaded with blowing agent to produce the cellular plastic particles under the influence of temperature can, for example, more particularly, depending on the chemical composition of the plastic particle material loaded with blowing agent and/or the blowing agent, be carried out at a temperature in a range between 20 and 300° C., more particularly, in a range between 20 and 290° C., further, more particularly, in a range between 20 and 280° C., further, more particularly, in a range between 20 and 270°, further, more particularly, in a range between 20 and 260° C., further, more particularly, in a range between 20 and 250° C., further, more particularly, in a range between 20 and 240° C., further, more particularly, in a range between 20 and 230° C., further, more particularly, in a range between 20 and 220° C., further, more particularly, in a range between 20 and 210° C., further, more particularly, in a range between 20 and 200° C., further, more particularly, in a range between 20 and 190° C., further, more particularly, in a range between 20 and 180° C., further, more particularly, in a range between 20 and 170° C., further, more particularly, in a range between 20 and 160° C., further, more particularly, in a range between 20 and 150° C., further, more particularly, in a range between 20 and 140° C., further, more particularly, in a range between 20 and 130° C., further, more particularly, in a range between 20 and 120° C., further, more particularly, in a range between 20 and 110° C., further, more particularly, in a range between 20 and 100° C., further, more particularly, in a range between 20 and 90° C., further, more particularly, in a range between 20 and 80° C., further, more particularly, in a range between 20 and 70° C., further, more particularly, in a range between 20 and 60° C., further, more particularly, in a range between 20 and 50° C., further, more particularly, in a range between 20 and 40° C., further, more particularly, in a range between 20 and 30° C. Any and all intermediate values not explicitly listed here are also conceivable.

The aforementioned temperatures can, more particularly, refer to an inlet temperature when the pre-expanded plastic material particles loaded with blowing agent enter a corresponding expansion device, and/or to an outlet temperature when the cellular plastic particles exit a corresponding expansion device. Corresponding inlet and outlet temperatures can be the same, similar or different. If a corresponding expansion device has a conveyor device which is set up to convey the plastic material particles loaded with blowing agent along corresponding temperature control devices, the aforementioned temperatures can refer to a temperature when the pre-expanded plastic particle material loaded with blowing agent enters a corresponding expansion or temperature control device (inlet temperature). i.e., to an initial area of a corresponding conveyor device, and/or to an outlet temperature when the plastic particles exit a corresponding expansion or temperature control device (outlet temperature), i.e., to an end area of a corresponding conveyor device. Typically, the inlet temperature is lower than the outlet temperature.

Expanding the pre-expanded plastic material particles loaded with blowing agent under the influence of temperature is carried out by irradiating the pre-expanded plastic particle material loaded with blowing agent with high-energy thermal radiation, i.e., more particularly, infrared radiation. More particularly, infrared radiation with wavelengths in a range between 1 and 15 μm, more particularly, between 1.4 and 8 μm, further, more particularly, between 1.4 and 3 μm, comes into consideration. The wavelengths of the infrared radiation are typically chosen depending on the material. Temperature control, i.e., more particularly, heating the pre-expanded plastic material particles loaded with blowing agent can, more particularly, depending on the material, be carried out in a very targeted manner by selecting and/or setting the properties of the high-energy radiation used, i.e., more particularly, its wavelength, without risking melting or fusing, i.e., insufficient stability of the softened plastic material particles, which is undesired for the expansion process of the plastic material particles loaded with blowing agent, in case of softening associated with heating the pre-expanded plastic material particles loaded with blowing agent. Studies have shown infrared radiation to be particularly suitable in this case, as it enables a targeted and, in conjunction with a conveyor device, very easily controllable volume heating of the pre-expanded plastic material particles loaded with blowing agent, a controllable softening process and thus—this is essential for setting the properties of the cellular plastic particles to be produced—a controllable expansion process.

More particularly, expanding the plastic material particles loaded with blowing agent can be carried out under the influence of temperature by irradiating the pre-expanded plastic material particles loaded with a blowing agent with high-energy thermal radiation, more particularly, infrared radiation, the plastic material particles loaded with blowing agent being conveyed on at least one conveyor line defined by a conveyor device, more particularly, continuously, along at least one radiation generating device generating corresponding high-energy radiation, i.e., more particularly, infrared radiation. A corresponding radiation generating device can, more particularly, be designed as, or include, an infrared oven, more particularly, an infrared continuous oven. A corresponding infrared oven can include one or more infrared emitters arranged, or formed, along a corresponding conveyor line.

Corresponding infrared emitters can, for example, have an, optionally variable, radiation output in a range between 1 and 500 kW, further, more particularly, in a range between 1 and 450 kW, further, more particularly, in a range between 1 and 400 kW, further, more particularly, in a range between 1 and 350 kW, further, more particularly, in a range between 1 and 250 kW, further, more particularly, in a range between 1 and 200 kW, further, more particularly, in a range between 1 and 150 kW, further, more particularly, in a range between 1 and 100 kW, further, more particularly, in a range between 1 and 50 kW. Instead of 1 kW, 2, 3, 4, 5, 6, 7, 8, 9 or 10 kW can also be used as the lower limit. Any and all intermediate values not explicitly listed here are also conceivable.

The aforementioned outputs can refer, more particularly, to area output per m². Studies showed that, more particularly, area outputs between 5 and 100 kW/m² gave good results. Different temperature zones can be created using variable radiators or variable radiator (area) outputs, which also provides a parameter for influencing the expansion process.

According to the method, after expanding the plastic material particles loaded with blowing agent to produce the cellular plastic particles under the influence of temperature (more particularly a lower temperature compared to the previously carried out expansion process), as indicated above, the cellular plastic particles produced can be cooled. By cooling, which is expediently rapid, the cellular structure of the cellular plastic particles present after the expansion process can be “frozen”. In this way, any further, integral or merely local, expansion of the plastic particles that may be undesirable after the expansion process can be specifically prevented, for example, in order to maintain a cellular structure of the plastic particles that may be desired after the expansion process. The cooling can, more particularly, occur from a process temperature above a reference temperature, more particularly, room temperature can be used as a reference temperature, to a cooling temperature below the process or reference temperature, more particularly, room temperature. Therefore, separate temperature control devices for cooling the plastic particles are not absolutely necessary, but it can be sufficient if the plastic particles are cooled to room temperature after the expansion process or stored at room temperature.

According to the method, as also indicated above, a pre-expanded plastic particle material can be provided or used, which contains at least one, more particularly, functional, additive or auxiliary material, for example, a fiber or fibrous material and/or a dye or color material and/or a nucleation substance or material and/or a substance or a material such as, for example, additives to adjust a melt viscosity, such as, for example, chain extenders, or to increase the absorption coefficient, such as graphite, carbon black, etc., for targeted influencing or controlling the softening characteristics of the plastic material particles loaded with blowing agent. Alternatively or additionally, a pre-expanded plastic particle material containing at least one additive from the group: antioxidant, UV stabilizer, antistatic additive, flow or non-stick additive, flame retardant additive, pigment, dye and mixtures of the aforementioned, can be provided or used. An antioxidant can, for example, be present in a percentage in a range between 0 and 2.5% by weight, more particularly, between 0 and 1% by weight; a UV stabilizer, such as, for example, amine or nickel-based UV stabilizers, can, for example, be present in a percentage between 0 and 5% by weight, more particularly, between 0 and 2.5% by weight (for amine or nickel-based UV stabilizers, more particularly, a percentage between 0 and 5% by weight applies, further, more particularly, between 0 and 2.5% by weight); an antistatic additive in a percentage between 0 and 5% by weight, more particularly, between 0 and 1% by weight−2.5% by weight; a flow or non-stick additive in a percentage between 0 and 5% by weight, more particularly, between 0 and 2.5% by weight; an anti-block additive in a percentage between 0 and 5% by weight, more particularly, between 0 and 2.5% by weight; a nucleation additive in a percentage between 0 and 5% by weight, more particularly, between 0 and 2.5% by weight, and a flame retardant additive in a percentage between 0 and 65% by weight, more particularly, between 0 and 20% by weight, further, more particularly, between 0 and 5% by weight, further, more particularly, between 0 and 2.5% by weight. Pigments or dyes, such as, for example, carbon black, can (each) be present in a percentage between 0 and 15% by weight.

Therefore, according to the method, compounded and pre-expanded plastic material particles can also be loaded with blowing agent and expanded, which leads to cellular plastic particles with special properties. More particularly, tailor-made plastic particles can be produced for specific applications or areas of use through a targeted selection and concentration of corresponding additives or auxiliary materials. The additives or auxiliary materials may have been introduced into the pre-expanded plastic material particles as part of the production thereof.

More particularly, fibers or fibrous materials—which can, in principle, be organic or inorganic fibers or fibrous materials, therefore, mention should be made of, for example, aramid, glass, carbon or natural fibers—can be used, with regard to further processing, to achieve special material properties of the cellular plastic particles that are producible or produced according to the method, or of a particle foam molding produced from the cellular plastic particles that are producible or produced according to the method. Corresponding cellular plastic particles or particle foam moldings produced therefrom can, on the one hand, due to their cellular structure, be characterized by a special density and, on the other hand, more particularly, according to the processing, due to mechanical connections of neighboring cells within respective cellular plastic particles and/or between respective neighboring cellular plastic particles, by special mechanical properties. During the subsequent processing into particle foam moldings, these special mechanical properties can be utilized locally or integrally, or even modified. The same applies in principle, regardless of their chemical composition, to non-fibrous or non-fiber-shaped additives or auxiliary materials, such as, for example, spherical or sphere-shaped or platelet-like or -shaped organic and/or inorganic additives or auxiliary materials.

In addition to influencing the mechanical properties of the plastic particles in a targeted manner, corresponding additives or auxiliary materials can be used to influence the electrical properties and/or thermal properties of the plastic particles in a targeted manner. Therefore, plastic particles with special electrically and/or thermally conductive properties can be produced, for example, by electrically and/or thermally conductive additives or auxiliary materials, such as, for example, metal and/or carbon black particles, etc.

The concentration of corresponding additives or auxiliary materials can, in principle, be chosen freely, although typically depending on the material. It is therefore merely stated by way of example that pre-expanded plastic material particles with one (or more) additive(s) or auxiliary material(s) in a (respective) concentration between 0.01% by weight, this applies, more particularly, to chemically active additives, and 60% by weight, this applies, more particularly, to fibrous additives, can be provided or used. As indicated, the concentration typically depends on the specific chemical and/or physical properties of the additives or auxiliary materials or the combination thereof.

It was mentioned that, according to the method, in principle any thermoplastic plastic material can be provided or used as starting material. Consequently, merely by way of example, it should be understood that polyolefin-based plastic material particles pre-expanded according to the method from the group: polypropylene, polypropylene blend, polyethylene, polyethylene blend, polyethylene-polypropylene blends, copolymers of ethylene and at least one other olefinic monomer, copolymer of propylene and at least one other olefinic monomer and/or mixtures of the aforementioned, are provided or used. Consequently, blends or mixtures of different thermoplastic polyolefin-based plastic materials can also be used; modified polyolefin (mPO) being only mentioned as an example in this context.

If polyolefin-based blends are used which contain at least two (poly)olefinic components that differ in at least one chemical and/or physical parameter and/or parameter relating to the molecular configuration, these blends can be present principally in any proportionate composition, with the respective percentages adding up to 100%. Accordingly, a first component can be present at any percentage by weight between 1 and 99% by weight and a second component can be present at any percentage by weight between 99 and 1% by weight, with the respective percentages adding up to 100% by weight. Of course, percentages below 1% by weight and above 99% by weight are also conceivable.

For example, a copolymer of propylene and at least one other olefinic component can be used, the percentage of the at least one olefinic monomer being in a range between 0.5 and 50% by weight, more particularly, a range between 1 and 10% by weight. In addition to ethylene/propylene, a corresponding olefinic monomer can also be butene, hexene, octene, etc. The same applies to a copolymer of ethylene and at least one other olefinic component.

Corresponding copolymers can have a melting temperature in a range between 100 and 140° C., more particularly, between 120 and 140° C., further, more particularly, above 140° C.

Likewise, mixtures of at least two different copolymers can be used. Merely as an example, reference is made to a mixture of a first copolymer of propylene and at least one olefinic component with a melting temperature above 140° C. (copolymer A) and another copolymer of propylene and at least one olefinic component with a melting temperature between 120 and 140° C. (copolymer B). The percentage of copolymer B, based on the total mixture, can be in a range between 0.1 and 50% by weight, more particularly, in a range between 0.1 and 25% by weight. The percentage of copolymer A is such that the percentages add up to 100% by weight.

As mentioned, any and all plastic materials used can be provided with one or more additives, such as, for example, fibers. Any and all plastic materials used can be recyclates, or can contain a percentage of recyclates.

It was mentioned that the properties of the cellular plastic particles of lower density that are producible or produced according to the method can be influenced, more particularly, by the process conditions during the loading process and the expansion process.

Consequently, according to the method, depending on the chosen process conditions, cellular plastic particles with a uniformly or non-uniformly distributed cellular structure can be produced, for example. Consequently, the properties. i.e., more particularly, the distribution of the cellular structure within respective cellular plastic particles, can be influenced, in addition to material-specific parameters, (also) by pressure, temperature and time during loading or expanding as well as by the conveying or residence times or conditions between the individual method steps.

If cellular plastic particles with a non-uniformly distributed cellular structure are produced according to the method, respective cellular plastic particles can have a different number, shape and/or size of cells in an edge region than in a core region. Therefore, graded cellular plastic particles can be produced which have a special range of properties due to the different distribution of cell number, cell shape and/or cell size. Consequently, graded cellular plastic particles can have different cellular properties in an (outer) edge region than in an (inner) core region, for example, in the manner of core-shell particles.

Correspondingly configured cellular plastic particles can be obtained, more particularly, by (too) briefly loading the compact starting material with blowing agent, which then only accumulates close to the edge, so that, subsequently, expansion occurs, more particularly, at the edge. Conversely, a (too) long storage period between blowing agent loading and expansion can lead to cellular plastic particles in which the “core” is predominantly foamed.

Generally, it is true that, according to the method, more particularly, cellular plastic particles with a cell size in a range between 0.5 and 250 μm can be produced. Consequently, according to the method, the actual cell size—of course, in this context, reference is typically made to an average—can be set over a very wide range and thus tailored, depending on the chosen process conditions. The same is true for any distribution of cell size within respective cellular plastic particles.

Generally, it is also true that, more particularly, depending on the degree of expansion and, optionally, filler content, cellular plastic particles with a bulk density in a range between 5 and 1000 g/l can be produced according to the method. Consequently, the actual bulk density—of course, in this context also, reference is typically made to an average—can be set over a very wide range and therefore tailored depending on the chosen process conditions.

Below, purely as an example, a pre-expanded plastic material particle that is specifically processible or has been processed as part of the method as well as associated parameters for carrying out the second and third step of the method are listed: In the context of the example, in the first step of the method, a pre-expanded expandable polypropylene plastic material. i.e., plastic material particles made of polypropylene, with a bulk density of approx. 75 g/l was provided. In the second step of the method, the pre-expanded plastic material particles were loaded with air as a blowing agent in a pressure container at a pressure of approx. 8 bar for a period of 100 hours without any special temperature control. The rate of pressure rise was approx. 0.2 bar per hour. In the third step of the method, the plastic material particles loaded with blowing agent were expanded by, more particularly, continuously or discontinuously conveying the pre-expanded plastic material particles loaded with blowing agent through an infrared continuous oven including several infrared emitters, i.e., by conveying the plastic material particles along a conveyor and temperature control line with a length of approx. 5 m formed by a plurality of temperature control elements in the form of infrared emitters with a total radiator output of approx. 20 kW. The temperature of the conveyor belt at the entrance to the conveyor line was approx. 85° C., the temperature of the conveyor belt at the exit of the conveyor or temperature control line was approx. 160° C. The conveying speed was approx. 450 mm/s. The cellular plastic particles produced in this way had a bulk density of approx. 35 g/l.

A second aspect of the invention relates to a particle foam material which is formed by or contains or includes cellular plastic particles which were produced according to the method according to the first aspect.

A third aspect of the invention enters a method for processing a plastic particle material according to the second aspect for producing a particle foam molding.

A fourth aspect relates to an apparatus for producing cellular plastic particles, more particularly, according to a method according to the first aspect, including:
a first device which is set up for loading the pre-expanded thermoplastic with a blowing agent under the influence of pressure, the device, more particularly, including a loading device, for example, in the form of a pressure container device; and
a second device which is set up for expanding the blowing agent for producing cellular plastic particles under the influence of temperature, the second device, more particularly, including expansion device in the form of a radiation generating device for generating high-energy radiation, more particularly, infrared radiation.

Consequently, the second device can, more particularly, be designed as, or include, a radiation-based heating device.

The second device can include a conveyor device, more particularly, a combined conveyor and temperature control device. A corresponding combined conveyor and temperature control device can be designed as, or at least include a continuous oven, more particularly, as an infrared continuous oven including one or more infrared emitters.

Furthermore, the second device can be associated with a relaxation device, such as, for example, a relaxation space in which the cellular plastic particles produced are stored (relaxed) under defined chemical and/or physical conditions, i.e., more particularly, defined temperature conditions, for a defined time. A corresponding relaxation device can be designed as, or include, a decompression device, for example.

It is conceivable that the apparatus further includes the, or a, conveyor device, by means of which the produced cellular plastic particles are conveyed continuously or discontinuously through a corresponding relaxation space.

The apparatus can further include suitable handling devices for handling the pre-expanded plastic material particles in order to provide them and/or to remove the produced cellular plastic particles. Corresponding handling devices can also be designed as, or include, conveyor devices. More particularly, conveyor devices suitable for conveying bulk material come into consideration, such as, for example, pneumatic conveyor devices, which are set up to form a conveying flow.

The apparatus can, principally, include a conveyor device, by means of which the pre-expanded plastic material particles or, furthermore, the cellular plastic particles can be conveyed continuously or discontinuously through the individual devices of the apparatus.

Any and all statements in connection with the method according to the first aspect apply analogously to the particle foam material according to the second aspect, the method according to the third aspect and the apparatus according to the fourth aspect.

The invention is explained below again by way of example using exemplary embodiments with reference to the figures. In the figures.

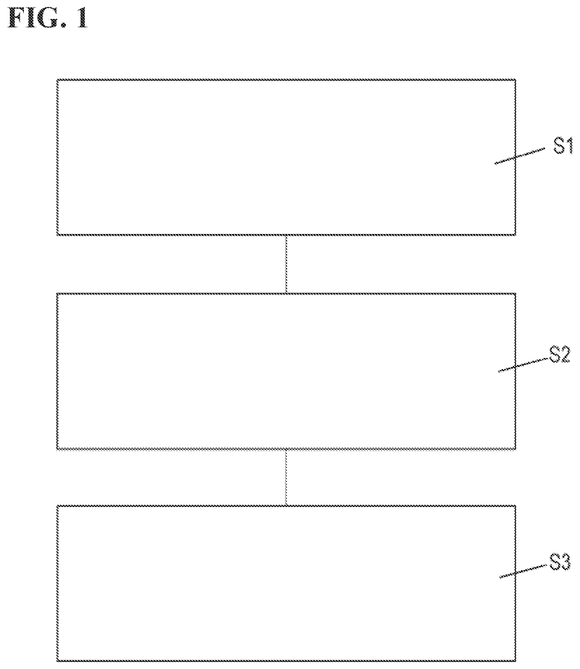

FIG. 1 shows a flowchart to illustrate a method according to an exemplary embodiment;

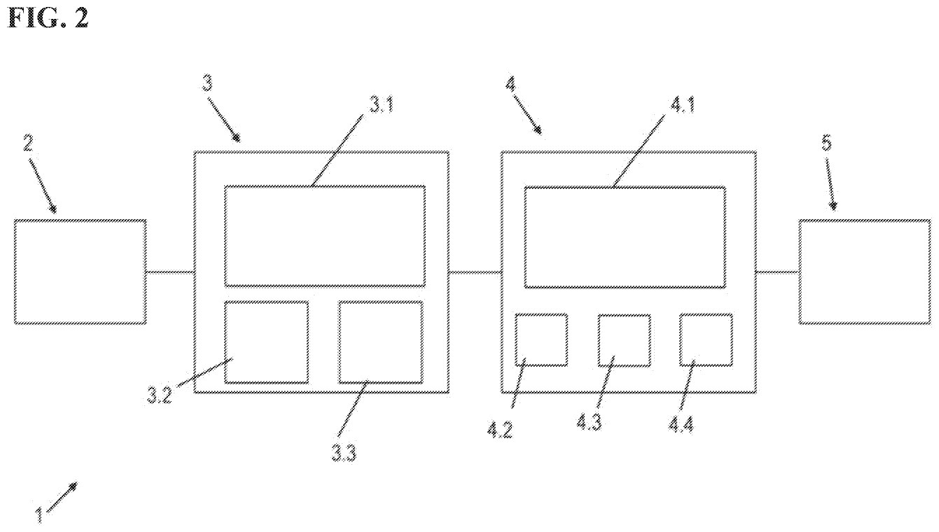

FIG. 2 shows a schematic representation of an apparatus for carrying out a method according to an exemplary embodiment; and

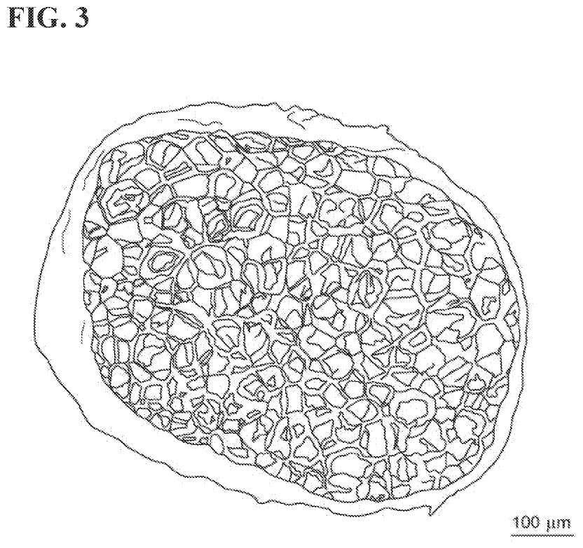

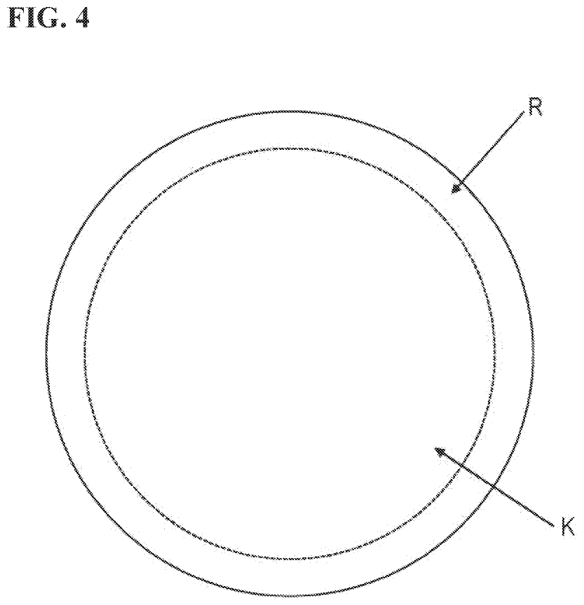

FIGS. 3, 4 each show a schematic representation of a cellular plastic particle produced according to the method according to an exemplary embodiment.

FIG. 1 shows a flowchart to illustrate a method according to an exemplary embodiment.

The method is a method for producing cellular plastic particles; consequently, the method is used to produce cellular plastic particles. The plastic particles that are producible or produced according to the method and which have a lower density compared to the starting material are, consequently, plastic particles which have a cellular structure at least in sections, optionally wholly. The plastic particles can also have a certain (further) expansion capacity, more particularly, due to a certain blowing agent content—be it a residue from the method described or introduced subsequently in a separate process step. The cellular plastic particles density that are producible or produced according to the method can, consequently, be expandable and/or (mechanically) compressible.

The cellular plastic particles with lower density that are producible or produced according to the method can be further processed into a particle foam molding in one or more independent subsequent processes. The further processing of the plastic particles into a particle foam molding can be carried out using steam or superheated steam (steam-based) or without the use of steam or superheated steam (non-steam based or dry).

The steps of the method for producing cellular plastic particles density are explained in more detail below with reference to FIGS. 1 and 2.

In a first step S1 of the method, a plastic material is provided in the form of pre-expanded plastic material particles. The pre-expanded plastic material particles provided can optionally also be referred to as “pre-expanded plastic particles”. The pre-expanded plastic material particles to be considered as starting material, which are typically thermoplastic plastic material particles, are, consequently, provided in the first step of the method. The starting material provided is therefore particulate, i.e., more particularly bulk-like or bulk-shaped. Consequently, in the first step, at least one measure is carried out for providing a particulate, i.e., more particularly, bulk-like or bulk-shaped (thermoplastic) plastic material in the form of corresponding pre-expanded plastic material particles. Depending on the material composition or modification, the density of the pre-expanded plastic material particles provided in the first step of the method is typically below 1 g/cm³, more particularly, in a range between 0.05 and 1.5 g/cm³, due to the cellular structure, which results in the pre-expanded properties of the pre-expanded plastic material particles provided; consequently, the matrix of the pre-expanded plastic material particles provided has a porous or cellular structure.

Despite its cellular structure, the matrix of the pre-expanded plastic material particles can optionally contain at least one additive or auxiliary material, such as, for example, elongated, spherical or platelet-shaped fillers. More particularly, for pre-expanded plastic material particles with additives or auxiliary materials, the density can optionally be above 1 g/cm³, depending on the concentration. Corresponding additives or auxiliary materials can optionally be present in cellular form itself or have a cellular effect.

The first step S1 of the method can be carried out, optionally at least partially automatable or partially automated, by means of a provision device 2 shown purely schematically in FIG. 2, which is set up for the continuous or discontinuous providing of corresponding pre-expanded plastic material particles. A corresponding provision device 2 can be, for example, a conveyor device, by means of which the pre-expanded plastic material particles to be processed into corresponding cellular plastic particles can be conveyed to or into a loading device 3 that carries out the second step of the method. A corresponding conveyor device can be designed as, or include, for example, a belt conveyor device or flow conveyor device. Consequently, conveying the pre-expanded plastic material particles to or into a loading device 3 carrying out the second step of the method can include receiving the pre-expanded plastic material particles into a conveying flow; consequently, the pre-expanded plastic material particles can be conveyed by means of a conveying flow to or into a loading device 3 which carries out the second step of the method.

In a second step S2 of the method, the pre-expanded plastic material particles are loaded with a blowing agent, at least under the influence of pressure. In the second step, the pre-expanded plastic material particles are loaded with a blowing agent at least under the influence of pressure—optionally, depending on the material, a certain (elevated) temperature can also be applied in addition to a certain pressure. In the second step, at least one measure for loading the pre-expanded plastic material particles with a blowing agent is generally carried out at least under the influence of pressure, i.e., at least pressurized. Phenomenologically, in the second step of the method, the blowing agent is typically enriched in the respective pre-expanded plastic material particles. The enrichment of the blowing agent in the respective pre-expanded plastic material particles can result, for example, from or through absorption and/or dissolution processes of the blowing agent in the respective pre-expanded plastic material particles, more particularly, depending on the chemical configuration of the pre-expanded plastic material particles, the blowing agent and the additives or auxiliary materials it optionally may contain, and, as previously mentioned, depending on the pressure or temperature conditions, which are typically also chosen depending on the materials. Because of the cellular structure of the pre-expanded plastic material particles an enrichment or accumulation of the blowing agent can also occur within the cell spaces provided by the cellular structure; i.e., the inner volume of a respective pre-expanded plastic material defined by the cell spaces can be utilized as a receiving space for the reception of blowing agent taking place in the second step of the method.

The pressure level and the rate of pressure rise in the second step of the method are typically chosen, particularly depending on the material, so that the cellular structure of the pre-expanded plastic material particles is not damaged; more particularly, the pressure level and rate of pressure rise in the second step of the method are chosen so that the cellular structure of the pre-expanded plastic material particles, due to pressure (effective difference between external loading pressure and internal cellular pressure), does not deform plastically and even collapse.

Gases such as, for example, carbon dioxide or a mixture containing carbon dioxide and/or nitrogen, such as, for example, air can be used as a blowing agent. Generally, any combustible or non-combustible organic gases, i.e., more particularly, butane or pentane; or inert gases, such as, for example, noble gases, i.e., more particularly, helium, neon, argon; or nitrogen, or mixtures thereof can be used. Consequently, the term “blowing agent” can also include a mixture of chemically and/or physically different blowing agents. The selection of the blowing agent typically takes into account its absorption capacity in the pre-expanded plastic material particles, i.e., taking into account the chemical and/or physical configuration or composition of the pre-expanded plastic material particles. If the pre-expanded plastic material particles contain additives or auxiliary materials, the properties such as, for example, the chemical and/or physical configuration of the additives or auxiliary materials can also be taken into account when selecting the blowing agent.

The second step S2 of the method can, optionally at least partially automatable or partially automated, be carried out by means of a loading device 3, shown purely schematically in FIG. 2, which is set up to load the pre-expanded plastic material particles with a blowing agent at least under the influence of pressure, or to carry out a corresponding loading process. A corresponding loading device 3 can, for example, be designed as, or include, an autoclave device, i.e., generally as a pressure container device 3.1 including a pressure or process space. A corresponding loading device 3 can also have a temperature control device 3.2, which is set up to control the temperature of a corresponding pressure or process space. A corresponding loading device can, in any case, have a control and/or regulation unit 3.3 which is implemented in hardware and/or software, which is set up for control and/or regulation, i.e., generally for setting certain dynamic and/or static pressure and/or temperature parameters within the pressure or process space.

In a third step of the method, the pre-expanded plastic material particles loaded with blowing agent are expanded to produce cellular plastic particles under the influence of temperature, i.e., more particularly, elevated temperature. Consequently, the pre-expanded plastic material particles loaded with blowing agent are typically exposed to elevated temperature in the third step of the method, i.e., generally to thermal energy, which leads to outgassing and/or expanding of the blowing agent contained in the pre-expanded plastic material particles. More particularly, the outgassing of the blowing agent in the cells and the matrix areas of the thermally softening or softened pre-expanded plastic material particles causes the plastic material particles to expand again or further, which, after cooling or “freezing”, results in the formation of plastic particles having a permanent cellular structure that may have changed compared to the starting material, for example in terms of cell number, cell shape and/or cell size, and thus in the formation of the cellular plastic particles to be produced. In the third step of the method, consequently, at least one measure for outgassing or expanding the blowing agent contained in the pre-expanded plastic material particles, which are, at least by the influence of temperature and thus at least thermally, softening or softened, is carried out to produce cellular plastic particles. Phenomenologically, in the third step of the method, more particularly, due to the outgassing or desorption of the blowing agent from the cells and the matrix areas of the softening or softened pre-expanded plastic material particles, optionally, a further cell growth and, optionally, a renewed cell formation with subsequent cell growth within the pre-expanded plastic material particles occur, which leads to the cellular plastic particles to be produced. The cell formation, if such occurring, is typically based on the aforementioned desorption of the blowing agent at nucleation points in the plastic material particles that are softening or softened by the influence of temperature, while the cell growth is typically based on a positive pressure-related expansion of the blowing agent in already formed or existing cells. As also mentioned, the cellular structure formed in this way or the further expansion state realized in this way is permanently “frozen” or fixed by the, or a. temperature reduction of the cellular plastic particles produced in this way, i.e., by cooling them, for example, by the environment.

Consequently, in principle, it is true that after completion of the pressurization, which occurs in the second step of the method, i.e., in the event of a pressure drop, more particularly, to normal or standard conditions, outgassing or desorption processes occur within respective pre-expanded plastic material particles loaded with blowing agent and typically thermally softened. The outgassing or desorption processes of the blowing agent represent an essential prerequisite for the cell growth processes required for the production of cellular plastic particles and, optionally, cell formation processes within respective plastic material particles. In the third step of the method, more particularly, due to corresponding outgassing or desorption processes, the cellular plastic particles to be produced according to the method are formed from the typically thermally softened, pre-expanded plastic material particles present after the second step of the method which are loaded with blowing agent. As will be explained below, by controlling corresponding outgassing or desorption-related cell formation and cell growth processes, optionally, cellular structures with locally different cell properties and thus graded cellular plastic particles can be realized.

Nucleation in conjunction with a targeted adjustment of the softening characteristics has a crucial influence on the desorption of the blowing agent. More particularly, a plurality of new small cells can be formed through a plurality of individual nucleation points, which leads to a fine cell structure within respective cellular plastic particles. A corresponding fine cell structure is characterized, more particularly, by small cells and a largely homogeneous distribution of these within the respective cellular plastic particles.

Generally, it is true that, according to the method, more particularly, cellular plastic particles with a cell size in a range between 0.5 and 250 μm can be produced. Consequently, the actual cell size—of course, here, typically reference is made to an average—can therefore be set over a very wide range and thus tailored according to the process depending on the selected process conditions. The same applies to any distribution of cell sizes within respective cellular plastic particles.

More particularly, it is true that the method can be used to form cellular plastic particles with a (mean) cell size below 100 μm, more particularly, below 75 μm, further, more particularly, below 50 μm, further, more particularly, below 25 μm.

The third step S3 of the method can be carried out, optionally at least partially automatable or partially automated, by means of an expansion device 4 which is set up for the radiation-based expanding of the blowing agent for producing cellular plastic particles at least under the influence of temperature to carry out a corresponding radiation-based expansion process. Consequently, a corresponding expansion device 4 is typically designed as, or includes, a radiation-based heating device, i.e., generally as a temperature control device 4.1 including a temperature control or process space, the temperature of which is controllable or controlled at least based on radiation. A corresponding temperature control device 4.1 can also have a conveyor device 4.3, which is set up to convey the plastic material particles to be expanded along a conveyor line through a corresponding temperature control or process space. A corresponding expansion device 4 can in all cases have a control and/or regulation unit 4.2 implemented in hardware and/or software, which is set up for control and/or regulation, i.e., generally, for setting certain dynamic and/or static conveying and/or temperature parameters within a corresponding temperature control or process space.

The density of the cellular plastic particles produced in the third step S3 of the method is typically well below the initial density of the pre-expanded plastic material particles provided in the first step S1, which results in the cellular properties of the plastic particles that are producible or produced according to the method. Accordingly, the bulk density of the cellular plastic particles produced in the third step S3 of the method is well below the bulk density of the pre-expanded plastic material particles provided in the first step S1 of the method.

The cellular plastic particles produced in the third step S3 of the method can be, as mentioned above, (further) expandable; this can represent an essential property for the described, more particularly, steam-based or non-steam-based, further processing of the cellular plastic particles for the production of particle foam moldings.

As indicated, the loading of the pre-expanded plastic material particles with a blowing agent can be carried out under the influence of pressure and temperature. Consequently, the parameters that can be varied, more particularly, depending on the material, for loading the pre-expanded plastic material particles with blowing agent and subsequently for the targeted setting of certain properties of the cellular plastic particles to be or are produced, are, consequently, initially the pressure and temperature conditions prevailing in the second step S2 of the method. Of course, time is also important. i.e., more particularly, the course and duration of the pressure and temperature conditions, in the second step of the method, a parameter which has influence on the loading of the pre-expanded plastic material particles with blowing agent, i.e., more particularly, the absorption and enrichment of the blowing agent in the pre-expanded plastic material particles.

Loading the pre-expanded plastic material particles with the, or a, blowing agent can, for example, more particularly, depending on the chemical composition of the pre-expanded plastic material particles and/or the blowing agent, be carried out at a pressure in a range between 1 and 200 bar, for example. The pressure refers, more particularly, to the pressure within a pressure or process space of a corresponding loading device 3 when the second step S2 of the method is carried out.

Loading the pre-expanded plastic material particles with the, or a, blowing agent can, for example, more particularly, depending on the chemical composition of the pre-expanded plastic material particles and/or the blowing agent, be carried out at a temperature in a range between 0 and 250° C., for example. The temperatures refer, more particularly, to temperatures within a pressure or process space of a corresponding loading device when the second step S2 of the method is carried out.

Loading the pre-expanded plastic material particles with the, or a, blowing agent can, for example, more particularly, depending on the chemical composition of the pre-expanded plastic material particles and/or the blowing agent, can be carried out for a period of time in a range between 0.1 and 1000 h, for example. As mentioned, the time periods mentioned above as examples relate, more particularly, to the pressure or temperature exposure of the plastic material particles within a pressure or process space of a corresponding loading device 2 when the second step S2 of the method is carried out.

Expanding the plastic material particles loaded with blowing agent to produce the cellular plastic particles under the influence of temperature, more particularly, depending on the chemical composition of the plastic particle material loaded with blowing agent and/or the blowing agent, can, for example, be carried out at normal pressure, i.e., at an ambient pressure of approx. 1 bar. Consequently, a particular pressure level, such as, for example, a positive or a negative pressure level is possible for expanding the pre-expanded plastic material particles loaded with blowing agent to produce the cellular plastic particles, but is not absolutely necessary, which fundamentally simplifies the expansion process.

Expanding the plastic material particles loaded with blowing agent to produce the cellular plastic particles under the influence of temperature can, for example, more particularly, depending on the chemical composition of the plastic particle material loaded with blowing agent and/or the blowing agent, be carried out at a temperature in a range between 0 and 300° C., for example. The aforementioned temperatures can, more particularly, refer an inlet temperature when the pre-expanded plastic material particles loaded with blowing agent enter a corresponding expansion device 4, and/or to an outlet temperature when the cellular plastic particles exit a corresponding expansion device 4. Corresponding inlet and outlet temperatures can be the same, similar or different. If a corresponding expansion device 4 has a conveyor device 4.31 which is set up to convey the plastic material particles loaded with blowing agent along corresponding temperature control devices 4.1, the aforementioned temperatures can refer to a temperature when the pre-expanded plastic particle material loaded with blowing agent enters a corresponding expansion or temperature control device 4.1 (inlet temperature), i.e., to an initial area of a corresponding conveyor device 4.3, and/or to an outlet temperature when the plastic particles exit a corresponding expansion or temperature control device 4 (outlet temperature), i.e., to an end area of a corresponding conveyor device. Typically, the inlet temperature is lower than the outlet temperature.

Expanding the pre-expanded plastic material particles loaded with blowing agent under the influence of temperature can be carried out by irradiating the pre-expanded plastic particle material loaded with blowing agent with high-energy thermal radiation, more particularly, infrared radiation. Temperature control, i.e., more particularly, heating the pre-expanded plastic material particles loaded with blowing agent can, more particularly, depending on the material, be carried out, consequently, in a targeted manner by selecting and/or setting the properties of high-energy radiation, i.e., more particularly, its wavelength, without risking melting or fusing, i.e., insufficient stability of the softened plastic material particles, which is undesired for the expansion process of the plastic material particles loaded with blowing agent, in case of softening associated with heating the pre-expanded plastic material particles loaded with blowing agent. Studies have shown infrared radiation to be particularly suitable in this case, as it enables a targeted and, in conjunction with a conveyor device, very easily controllable volume heating of the pre-expanded plastic material particles loaded with blowing agent, a controllable softening process and thus—this is essential for setting the properties of the cellular plastic particles to be produced—a controllable expansion process.

More particularly, expanding the plastic material particles loaded with blowing agent can be carried out under the influence of temperature by irradiating the pre-expanded plastic material particles loaded with a blowing agent with high-energy thermal radiation, more particularly, infrared radiation, the plastic material particles loaded with blowing agent being conveyed on at least one conveyor line defined by a conveyor device 4.3, more particularly, continuously, along at least one radiation generating device 4.4 generating corresponding high-energy radiation, i.e., more particularly, infrared radiation. A corresponding radiation generating device 4.4 can, more particularly, be designed as, or include, an infrared oven, more particularly, an infrared continuous oven. A corresponding infrared oven can include one or more infrared emitters arranged, or formed, along a corresponding conveyor line. Corresponding infrared emitters can, for example, have an, optionally variable, radiation output in a range between 1 and 500 kW. The aforementioned outputs can refer, more particularly, to area output per m². More particularly, area outputs between 5 and 100 kW/m² can be used. Different temperature zones can be created using variable radiators or variable radiator (area) outputs, which also provides a parameter for influencing the expansion process.

According to the method, after expanding the plastic material particles loaded with blowing agent to produce the cellular plastic particles under the influence of temperature (more particularly a lower temperature compared to the previously carried out expansion process), as indicated above, the cellular plastic particles produced can be cooled. By cooling, which is expediently rapid, the cellular structure of the cellular plastic particles present after the expansion process can be “frozen”. In this way, any further, integral or merely local expansion of the plastic particles that may be undesirable after the expansion process can be specifically prevented, for example, in order to maintain a cellular structure of the plastic particles that may be desired after the expansion process. The cooling can, more particularly, occur from a process temperature above a reference temperature, more particularly, room temperature can be used as a reference temperature, to a cooling temperature below the process or reference temperature, more particularly, room temperature. Therefore, separate temperature control devices for cooling the plastic particles are not absolutely necessary, but it can be sufficient if the plastic particles are cooled to room temperature after the expansion process or stored at room temperature.

According to the method, as also indicated above, a pre-expanded plastic particle material can be provided or used, which contains at least one, more particularly, functional, additive or auxiliary material, for example a fiber or fibrous material and/or a dye or color material and/or a nucleation substance or material and/or a substance or material for targeted influencing or controlling the softening characteristics of the plastic material particles loaded with blowing agent. Therefore, according to the method, compounded pre-expanded plastic material particles can also be loaded with blowing agent and expanded, which leads to cellular plastic particles with special properties. More particularly, tailor-made plastic particles can be produced for specific applications or areas of use through a targeted selection and concentration of corresponding additives or auxiliary materials. The additives or auxiliary materials may have been introduced into the pre-expanded plastic material particles as part of the production thereof.

More particularly, fibers or fibrous materials—which can, in principle, be organic or inorganic fibers or fibrous materials, therefore, mention should be made of, for example, aramid, glass, carbon or natural fibers—can be used, with regard to further processing, to achieve special material properties of the cellular plastic particles that are producible or produced according to the method, or of a particle foam molding produced from the cellular plastic particles that are producible or produced according to the method. Corresponding cellular plastic particles or particle foam moldings produced therefrom can, on the one hand, due to their cellular structure, be characterized by a special density and, on the other hand, more particularly, according to the processing, due to mechanical connections of neighboring cells within respective cellular plastic particles and/or between respective neighboring cellular plastic particles, by special mechanical properties. During the subsequent processing into particle foam moldings, these special mechanical properties can be utilized locally or integrally, or even modified. The same applies in principle, regardless of their chemical composition, to non-fibrous or non-fiber-shaped additives or auxiliary materials, such as, for example, spherical or sphere-shaped or platelet-like or -shaped organic and/or inorganic additives or auxiliary materials.

In addition to influencing the mechanical properties of the plastic particles in a targeted manner, corresponding additives or auxiliary materials can be used to influence the electrical properties and/or thermal properties of the plastic particles in a targeted manner. Therefore, plastic particles with special electrically and/or thermally conductive properties can be produced, for example by electrically and/or thermally conductive additives or auxiliary materials, such as, for example, metal and/or carbon black particles, etc.

The concentration of corresponding additives or auxiliary materials can, in principle, be chosen freely, although typically depending on the material. It is therefore merely stated by way of example that pre-expanded plastic material particles with one (or more) additive(s) or auxiliary material(s) in a (respective) concentration between 0.01% by weight, this applies, more particularly, to chemically active additives, and 60% by weight, this applies, more particularly, to fibrous additives, can be provided or used. As indicated, the concentration typically depends on the specific chemical and/or physical properties of the additives.

According to the method, in principle, any polyolefin-based plastic material can be provided or used as starting material. For example, according to the method, plastic material particles from the group: polypropylene, polypropylene blend, polyethylene, polyethylene blend, polyethylene-polypropylene blends, copolymers of ethylene and at least one other olefinic monomer, copolymer of propylene and at least one other olefinic monomer and/or mixtures of the aforementioned, can be provided or used.

If polyolefin-based blends are used which contain at least two (poly)olefinic components that differ in at least one chemical and/or physical parameter and/or parameter relating to the molecular configuration, these blends can be present, principally, in any proportionate composition, with the respective percentages adding up to 100%. Accordingly, a first component can be present at any percentage by weight between 1 and 99% by weight and a second component can be present at any percentage by weight between 99 and 1% by weight, with the respective percentages adding up to 100% by weight. Of course, percentages below 1% by weight and above 99% by weight are also conceivable.

According to the method, depending on the chosen process conditions, cellular plastic particles with a uniformly or non-uniformly distributed cellular structure can be produced, for example. Consequently, the properties, i.e., more particularly, the distribution of the cellular structure within respective cellular plastic particles, can be influenced, in addition to material-specific parameters, (also) by pressure, temperature and time during loading or expanding as well as by the conveying times or conditions between the individual method steps S1-S3.

If cellular plastic particles with a non-uniformly distributed cellular structure are produced according to the method, respective cellular plastic particles can have a different number and/or shape and/or size of cells in an edge region than in a core region. Therefore, graded cellular plastic particles can be produced which have a special range of properties due to the different distribution of cell number, cell shape and/or cell size. Consequently, graded cellular plastic particles can have different cellular properties in an (outer) edge region than in an (inner) core region, for example, in the manner of core-shell particles.

Generally, it is also true that, more particularly, depending on the degree of expansion and, optionally, filler content, cellular plastic particles with a bulk density in a range between 5 and 1000 g/l can be produced according to the method. Consequently, the actual bulk density—of course, in this context also, reference is typically made to an average—can be set over a very wide range and therefore tailored depending on the chosen process conditions.

The exemplary embodiment of an apparatus 1 for carrying out the method shown in FIG. 2 includes the provision device 2 mentioned, the loading device 3, which can generally be referred to as the first device which is set up for loading the pre-expanded thermoplastic with a blowing agent under the influence of pressure, and the expansion device 4, which can generally be referred to as the second device, which is set up for expanding the blowing agent for the production of cellular plastic particles under the influence of temperature.

The provision device 2 can include a suitable handling device for handling the pre-expanded plastic material particles in order to provide them. In an analogous manner, the apparatus 1, although not shown, can include a handling device 5 downstream of the expansion device 4 for removing the cellular plastic particles produced. As mentioned, corresponding handling devices can be designed as, or include, conveyor devices. More particularly, conveyor devices suitable for conveying bulk material come into consideration, such as, for example, pneumatic conveyor devices, which are set up to form a conveying flow.

As mentioned, the second device can include a conveyor device, more particularly, a combined conveyor and temperature control device. A corresponding combined conveyor and temperature control device can, for example, be designed as, or at least include a continuous oven, more particularly, as an infrared continuous oven including one or more infrared emitters.

Furthermore, the second device can be associated with a relaxation device (not shown), such as, for example, a relaxation space in which the cellular plastic particles produced are stored under defined chemical and/or physical conditions, i.e., more particularly, defined temperature conditions, for a defined time. A corresponding relaxation device can be designed as, or include, a decompression device, for example.

In all exemplary embodiments, it is conceivable that the apparatus 1 includes a conveyor device, by means of which the pre-expanded plastic material particles or, subsequently, the cellular plastic particles are conveyed continuously or discontinuously through the individual devices 2-4.

FIG. 3 shows a schematic representation of a cellular plastic particle produced according to the method according to an exemplary embodiment in sectional view. Specifically, this is a section of a microscopic image of a foam bead made by cellular plastic particles produced according to the method from pre-expanded polypropylene (EPP) with an initial bulk density of approx. 75 g/l, with a reduced bulk density of approx. 17 g/l.

FIG. 4 shows a schematic representation of a cellular plastic particle produced according to the method according to an exemplary embodiment. The schematic representation shows a cellular plastic particle with locally different cell properties and thus a graded cellular plastic particle. Specifically, the cellular plastic particle has a non-uniformly distributed cellular structure, in that the plastic particle has a different, namely a higher number of cells in an edge region R than in a core region K. The dashed inner line indicates that the transitions between the edge region R and the core region K can be continuous. The edge region R can, optionally, be more or less distinct locally.

1. A method for producing cellular plastic particles, comprising:
providing a plastic material in the form of pre-expanded polyolefin-based plastic material particles,
loading the pre-expanded polyolefin-based plastic material particles with a blowing agent under the influence of pressure, and
expanding the pre-expanded polyolefin-based plastic material particles loaded with the blowing agent in order to produce cellular polyolefin-based plastic particles, under the influence of temperature,
wherein the expanding of the polyolefin-based plastic material particles loaded with the blowing agent is carried out under the influence of temperature by irradiation of the polyolefin-based plastic material particles loaded with the blowing agent with high-energy thermal radiation, more particularly, infrared radiation.

2. The method according to claim 1, wherein the loading of the pre-expanded polyolefin-based plastic material particles with the blowing agent is additionally carried out under the influence of temperature.

3. The method according to claim 1, wherein the loading of the pre-expanded polyolefin-based plastic material particles with the blowing agent, more particularly, depending on the chemical and/or physical composition of the polyolefin-based plastic material particles, is carried out at a pressure in a range between 1 and 200 bar.

4. The method according to claim 2, wherein the loading of the pre-expanded polyolefin-based plastic material particles with the blowing agent, more particularly, depending on the chemical and/or physical composition of the polyolefin-based plastic material particles, is carried out at a temperature in a range between 0 and 250° C.; and/or
the loading of the pre-expanded polyolefin-based plastic material particles with the blowing agent, more particularly, depending on the chemical composition of the polyolefin-based plastic material particles, is carried out for a period of time in a range between 0.1 and 1000 h.

5. The method according to claim 1, wherein the expanding of the plastic material particles loaded with the blowing agent is carried out under the influence of temperature, more particularly, depending on the chemical composition of the polyolefin-based plastic material particles loaded with blowing agent, at a temperature in a range between 20 and 300° C.

6. The method according to claim 1, wherein the expanding of the polyolefin-based plastic material particles loaded with blowing agent is carried out under the influence of temperature by irradiation of the polyolefin-based plastic material particles loaded with the blowing agent with high-energy thermal radiation, more particularly, infrared radiation, wherein the polyolefin-based plastic material particles loaded with the blowing agent are conveyed on at least one conveyor line along at least one corresponding radiation generating device generating high-energy radiation.

7. The method according to claim 1, wherein, after expanding the polyolefin-based plastic material particles loaded with the blowing agent, in order to produce the cellular polyolefin-based plastic particles under the influence of temperature, the cellular polyolefin-based plastic particles are cooled from a process temperature to a cooling temperature below the process temperature.

8. The method according to claim 1, wherein the pre-expanded polyolefin-based plastic material particles are provided or used, which contain at least one, more particularly, functional, additive or auxiliary material, more particularly, a fiber or fibrous material and/or a dye or color material and/or nucleation agents and/or additives for specifically influencing the softening characteristics, and/or at least one additive from the group: antioxidant, UV stabilizer, antistatic additive, flow or non-stick additive, flame retardant additive, anti-blocking additive, nucleation additive, pigment, dye and mixtures of the aforementioned, wherein, more particularly, pre-expanded polyolefin-based plastic material particles with at least one additive or auxiliary material in a concentration between 0.01% by weight and 60% by weight are provided or used.

9. The method according to claim 1, wherein pre-expanded polyolefin-based plastic material particles are provided or used from the group: polypropylene, polypropylene blend, polyethylene, polyethylene blend, polyethylene-polypropylene blends, copolymers of ethylene and at least one other olefinic monomer, copolymer of propylene and at least one other olefinic monomer and/or mixtures of the aforementioned.

10. The method according to claim 1, wherein cellular polyolefin-based plastic particles with a uniformly or non-uniformly distributed cellular structure are produced, wherein, more particularly, cellular polyolefin-based plastic particles with a non-uniformly distributed cellular structure can be produced within respective cellular polyolefin-based plastic particles, wherein respective cellular plastic particles have a different number and/or size and/or shape of cells in an edge region than in a core region.

11. The method according to claim 1, wherein a combustible or non-combustible organic gas; or an inert gas comprising noble gases; or nitrogen, carbon dioxide, or a mixture comprising air is used as the blowing agent.

12. The method according to claim 1, wherein cellular polyolefin-based plastic particles are produced with a cell size in a range between 1 and 250 μm, more particularly, a cell size below 25 μm.

13. The method according to claim 1, characterized in that cellular polyolefin-based plastic particles are produced with a bulk density in a range between 5 and 1000 g/l.

14. A plastic particle material which is formed by or comprises cellular polyolefin-based plastic particles which are produced according to a method according to claim 1.

15. An apparatus (1) for producing cellular polyolefin-based plastic particles, more particularly, according to a method according to claim 1, comprising:
a first device which is set up for loading pre-expanded polyolefin-based plastic material particles with a blowing agent under the influence of pressure, the device, more particularly, comprising a pressure container device; and
a second device which is set up for expanding the blowing agent for producing cellular polyolefin-based plastic particles under the influence of temperature, the second device comprising a radiation generating device for generating high-energy radiation, more particularly, infrared radiation.
